(19) United States
(12) Patent Application Publication
(10) Pub. No.: US 2010/0178212 A1
(43) Pub. Date: Jul. 15, 2010

(54) Cavitation Reactor

(76) Inventor: Sergei Dmitrievich Shestakov, Vologda (RU)

Correspondence Address: PAULEY PETERSEN & ERICKSON, 2800 WEST HIGGINS ROAD, SUITE 365, HOFFMAN ESTATES, IL, 60169, US

(21) Appl. No.: 12/223,244

(22) PCT Filed: Apr. 19, 2006
(86) PCT No.: PCT/RU2006/000194

§ 371 Date: Jul. 25, 2008

(51) Int. Cl. B01J 19/10; B01F 11/02

(52) U.S. Cl. 422/127

(57) ABSTRACT

An action on liquids by the energy of a cavitation acoustic field, which is generated by ultrasonic frequency elastic oscillations of a liquid, in such a way that athermodynamic disequilibrium state is formed in the liquids. Such a mechanism for transmitting energy to a liquid is an epithermal mechanism and produces therein the process which is inherent to high-energy physics and chemistry. It makes it possible, for example, to accumulate a certain quantity of energy in water by destroying the internal structure thereof formed by hydrogen bonds of individual molecules therebetween, practically without heating it and afterwards, to release the energy in the form of a hydration heat, while the water recovers the equilibrium state thereof or interacts with other substance. The cavitation reactor of this invention includes a harmonic oscillation source in the form of equifrequential resonators in which liquid oscillations produce elastic stationary waves. The reactor has a harmonic oscillation source embodied so that it enables the advance phase shift of the resonators proportionally to the displacement thereof away from the reactor center. The reactor also has a phase shift value of each resonator equal to the ratio between the distance of the oscillation units of the resonators to the reactor center and the wavelength in the liquid.

### BACKGROUND OF THE INVENTION

1. Field of the Invention

This invention relates to an apparatus for transforming the energy of an acoustic cavitation field in liquid when cavitation occurs in a space of elastic waves propagating in liquid, in order to disperse, homogenize and disintegrate the solid and liquid phases in liquid. Such mechanism of energy dissipation in liquid is epithermal and uses processes in liquid that are typical to high-energy physics and chemistry processes and accompanied by an onset of thermodynamically non-equilibrium states. This makes it possible, for instance, to accumulate a certain amount of energy in water due to isothermal destruction of its internal structure formed by hydrogen bonds between individual molecules, and then, during relaxation of this non-equilibrium state or when water combines with other substances, to release this energy in the form of hydration heat.

This invention can be used in chemical, food, pharmaceutical and fragrance industries, as well as in medicine and the power industry.

2. Discussion of Related Art

A cavitation reactor is known for processing liquid media and forms a liquid-filled chamber, with its interior space bounded between the housing surfaces, acoustic wave emitters and the walls reflecting these waves. Regardless of how many emitters there are in the reactor, they form a single acoustic wave. The reactor housing inside dimensions are selected based on the profile and dimensions of the wave front, such as taught by Russian Patent Reference RU 2209112, Jun. 4, 2002. Density distribution of potential energy of cavitation in liquid has global maximum and local minimums. The housing inside dimensions are chosen based on the condition of placing its wall surfaces in the region of minimum density of potential energy, in order to prevent erosion damage of wall surfaces and contamination of the processed liquid with products of erosion. One cannot increase the mean value of energy density in the chamber space by changing the area of the emitting surface because this will result in shifting extreme values of energy density and necessitate changing the housing dimensions. Increasing static pressure inside the reactor in order to achieve this result will lead to the need to increase the emitter power. There are devices with several emitters and reflectors of waves generated by the emitters, which together form acoustic resonators, such as taught by PCT Reference WO 2000/035579, 22 Jun. 2000, and by U.S. Pat. No. 4,618,263, Oct. 21, 1986. In these devices, there are no requirements to the phase ratio of oscillations that form these waves and thus they are not controlled in these reactors. In addition, in a reactor taught by U.S. Pat. No. 4,618,263, Oct. 21, 1986, one cannot increase cavitation energy density by increasing static pressure in the reactor because it constitutes an open unsealed vessel.

Known are cavitation reactors intended for using cavitation energy to affect the flow of liquid. They also contain resonance cells or resonators such as taught by Russian Patent Reference 2226428, Apr. 17, 2003, and PCT Reference WO 2005/018801, Mar. 3, 2005. These reactors have liquid flow diaphragms in the cross-section where density of potential energy of cavitation, which depends on the acoustic power of resonators, has a certain preset level. The type of energy density distribution in the reactor such as taught by Russian Patent Reference RU 2226428 is determined by distribution of the erosion coefficient, while in the reactor such as taught by PCT Reference WO 2005/018801 is determined directly. In these reactors, it is possible to increase the modulus of potential energy density in the reactor space by increasing emitter areas and/or hydrostatic pressure in work chambers. However, in this case it is necessary to increase the power of emitters.

The closest device with the same purpose is a cavitation reactor such as taught by Russian Patent Reference RU 2228217, May 21, 2003 for processing liquid media that constitutes a sealed chamber filled with liquid. The reactor can be equipped with several emitters. Together with specially equipped walls that reflect emitter-generated elastic waves in the liquid and with the liquid itself, they constitute acoustic resonators wherein a stationary wave is established. A specified distribution of potential energy density in the reactor at its given mean value is established by selecting the value of distribution variance from its mean value by changing an area of the resonators and chamber dimensions. In other words, one can increase density of potential energy in the reactor internal volume by changing resonator dimensions, changing the emitters and areas of reflecting walls within the specified variance range, as well as by increasing hydrostatic pressure in the reactor.

This reactor has been chosen as the prototype and the prototype shortcomings are as follows. First, both possible methods for increasing the absolute value of potential energy density in the reactor internal volume require a corresponding change of emitters power. Secondly, it is impossible to change wave phases in individual resonators because the required variance value is set based on the condition of one wave or several waves with the same wave phases acting inside the reactor.

### SUMMARY OF THE INVENTION

The essence of this invention is as follows. It is known that cavitation in the space of elastic waves sets in the form of so-called stationary cavities forming individual cavitation bubbles and located in oscillation nodes. Whatever the distortion of the disturbance profile of pressure propagating from each cavitation bubble, due to the change of the value of the modulus and direction of its velocity fluctuation vector, the average speed of disturbance propagation through the cavity over the harmonic wave period is equal to the speed of sound in liquid. Otherwise, the law of conservation of pressure momentum would be violated. Thus, pressure disturbances from cavitation bubbles over the harmonic wave period will on average pass the distance in liquid equal to the wavelength in liquid. In any point of a space, phases of these pressure disturbances from cavity areas of bubbles distributed in the space will not coincide for the same reason, the existence of the constant of the speed of propagation of elastic disturbances in liquid. This fact results in the known phenomenon of mutual suppression of pressure disturbances due to their interference and does not make it possible to amplify these pressure disturbances that propagate from individual bubbles by overlapping individual expansions or compressions at an arbitrary point inside cavitating liquid without controlling ripple phases of each individual bubble. It is clear that such control is technically impossible. However, one can control phases of individual waves that have cavities of a finite number of bubbles in oscillation nodes. In other words, it is possible to perform phase control of interference of the acoustic field of cavitation generated by the totality of plane elastic waves propagating simultaneously and independently of each other in a single common volume of liquid in order to add same size waves, for example amplify cavitation pressure disturbances.

The technical result is increasing the maximum value of density of potential energy of cavitation by redistributing it inside the cavitation reactor with the constant reactor volume, regardless of hydrostatic pressure inside the reactor and without a corresponding change of volume density of acoustic power of harmonic waves that generate cavitation.

In implementing this invention, the technical result is achieved by a known cavitation reactor for processing liquid media containing a source of harmonic oscillations in the form of resonators having the same frequency, which form elastic stationary waves in liquid. The source of harmonic oscillations has the capability to shift phases forward as the distance from the reactor center increases.

Another distinction is that the amount of phase shift of each resonator is equal to the ratio of the distance between the resonator oscillation node and the reactor to the wavelength in liquid. In this case, as they get closer to the reactor center, pressure pulses generated by cavities formed by each elastic wave will have the same sign and maximum absolute value at any given time, which will result in increased density of potential energy in the center. As is well known, in this case this value will be proportional to the square of cumulative pressure disturbance from all cavities of all resonators. Thus, the intensity of cavitation effect on flow of liquid will also be at its maximum. In this case, the reactor dimensions and resonator walls area will remain the same and it will not be necessary to increase the emitter power.

### BRIEF DESCRIPTION OF DRAWINGS

FIG. 1 shows a cross-section taken along a diametral plane of the housing of a round in a plan view cavitation reactor with three acoustic resonators, each with two solid state waveguides, and oscillation nodes in liquid shown in the cross-section view are shown with dotted lines, and the zero denotes the point that is the reactor center;

FIG. 2 shows a cross-section of the reactor shown in FIG. 1, taken in the plane where the oscillation nodes are located, and a view on resonator waveguides coincides with oscillation nodes projections on waveguides;

FIG. 3 shows a cross-section taken in the plane where the oscillation nodes of a reactor are similar to the reactor shown in FIG. 1 but which has seven acoustic resonators;

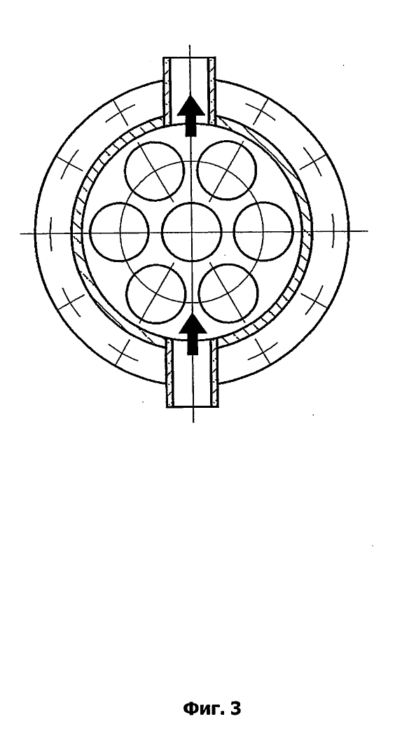

FIG. 4 shows a cross-section taken in the plane where the oscillation nodes of a reactor are similar to the reactor shown in FIG. 1 but which has two resonators, one of the resonators located on the axis of symmetry and is similar, in shape and dimensions, to the resonator shown in FIGS. 1-2, and the waveguides of the second resonator are made in the form of tubes that envelop, with clearance, the waveguides of the first resonator and have the wall thickness equal to their diameters;

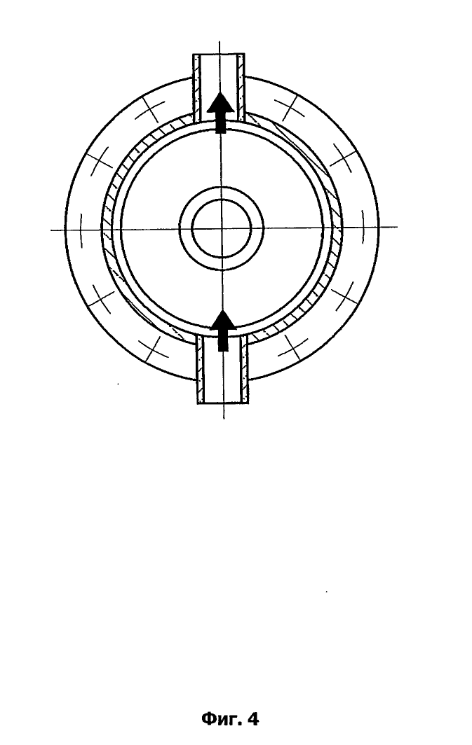

FIG. 5 shows a cross-section taken along the diametral plane of the housing of a rectangular in a plan view cavitation reactor with four acoustic resonators, each having two solid-state waveguides; and

FIG. 6 shows a cross-section of the reactor as shown in FIG. 5 but in the plane where the oscillation nodes are located.

### DETAILED DESCRIPTION OF THE INVENTION

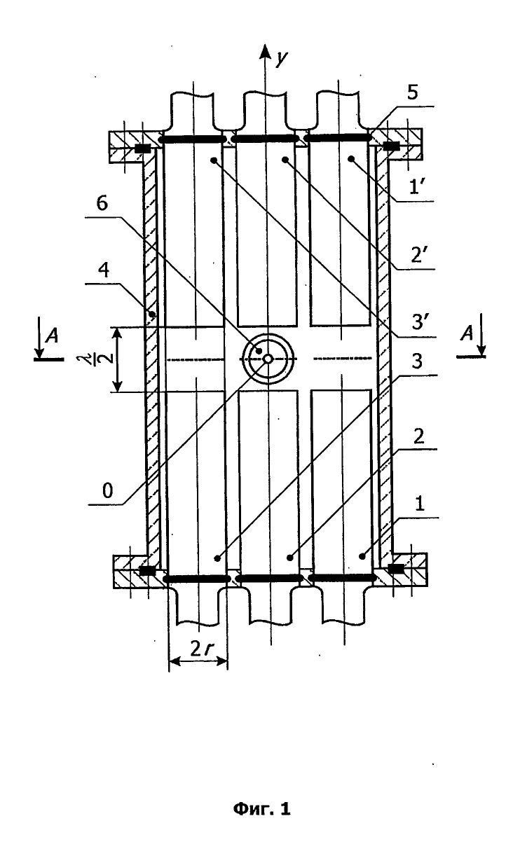

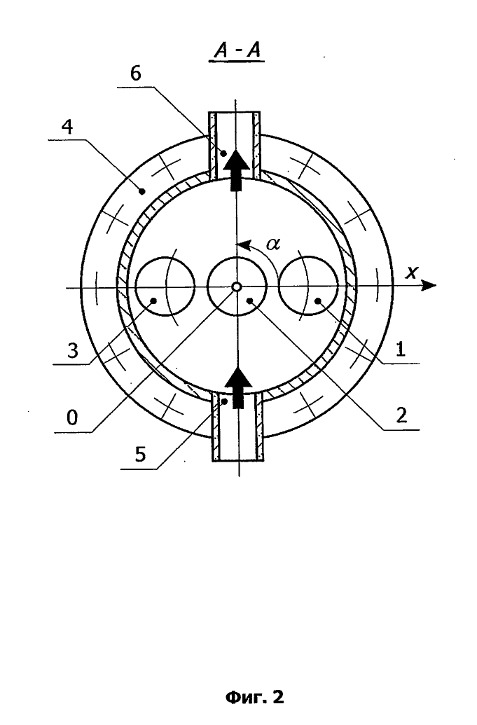

The claimed cavitation reactor, for instance, the one shown in FIGS. 1 and 2, includes three acoustic resonators, each having a pair of solid-state waveguides 1, 1′; 2, 2′; and 3, 3′, located opposite each other. They are actuated by electroacoustic transducers (not shown on the drawing), by transforming electric energy into mechanical energy of oscillations and transmitting the oscillations to liquid by the waveguides. The distance between waveguide surfaces in the resonators is equal, for instance, as shown in FIG. 1, to half-length of the elastic wave in the processed liquid. The transducer can be connected either to one of the waveguides that constitute or form the resonator, which in this case is called the active wall, or to both waveguides. In the first case, the condition of establishing resonance among the waveguides in liquid is achieved automatically, because the second waveguide, the passive wall, will oscillate at the same frequency as the first one. In the second case, the resonance must be achieved by establishing equal frequencies of transducer oscillations. This can be done by providing them with power from a common power source controlled by a common master frequency generator. Because resonators 1-1′ and 3-3′ are located at the same distance from the reactor center, their oscillation phases must be the same. Therefore, transducers activating waveguides 1, 1′, 3 and 3′ can be controlled by one master frequency generator. Thus, reactor resonators are controlled by two frequency generators: one is controlled by transducers activating waveguides 2 and 2′, and the other one by waveguides 1, 1′, 3 and 3′. As a wave frequency setting device, one can use devices described, for instance, by U.S. Pat. No. 4,556,467, Dec. 3, 1985.

Waveguides in the reactor and nodes of oscillations of liquid between them have in a plan view the shape of circles with a radius r equal to one quarter of the wavelength in the resonator. The waveguides are connected to reactor housing 4 by elastic gaskets 5 that ensure housing tightness. This attachment is done as is known with waveguide natural oscillation units, for example in such a way as to make it possible to install, using the resonators they form, acoustic waves with different and independent of each other phases without dissipation of oscillation power by the housing. The processed liquid is fed through the reactor via fittings 5 and 6. Point 0 is the reactor center.

The reactor parameters are calculated as follows.

Let water be the processed liquid, where the speed of sound propagation is 1450 m/s, and the transducer wave frequency is 20 kHz. Then the wavelength of oscillations in water D=1450:20=72.5 mm. The diameter of waveguides in oscillation nodes in the liquid is 0.5 D=36.3 mm, and the clearance in a plan view between the waveguides is equal to 3.6 mm.

As known, the average distance from an arbitrary point in space to all points of the circle that is in the same plane with it is equal to:

$$\frac{1}{π {r}^{2}} {\int }_{( π {r}^{2} )} \int r \sqrt{{r}^{2} + {x}^{2} - 2 xr cos α} d α d r$$

where x is the distance between this point and the center of the circle of radius r.

Using this double integral and the fact that the distances between the geometric centers of resonators 1-1′, 3-3′ and the reactor center are the same and equal to 36.3+3.6=39.9 mm, one can calculate the distance from this center to the oscillation node pertaining to resonator 2-2′ and nodes pertaining to resonators 1-1′ and 3-3′. These distances can be 12.1 mm and 41.0 mm, respectively. Thus, oscillation phases of resonators 1-1′, 3-3′ and 2-2′ with respect to the phase reference point must be shifted forward, and the amount of phase shift must be 41.0:72.5=0.566 and 12.1:72.5=0.167 of the wave period. In other words, at any given moment wave phases in resonators 1-1′ and 3-3′ must be ahead of the wave phase in resonator 2-2′ by 0.566−0.167=0.399 of the wave period. As the wave period is equal to 10⁶:20000=50 μs, the advance phase shift in peripheral resonators with respect to the central resonator will be equal, in absolute units, to 50·0.399=20 μs.

The reactor shown in FIGS. 1 and 2 works as follows.

When electroacoustic transducers are activated, elastic stationary waves are established inside each resonator in liquid, and their phases in peripheral resonators 1-1′ and 3-3′ are 20 microseconds ahead of the phase in resonator 2-2′ located in the center. Thus, pressure disturbances generated by cavities in the reactor reach the center of its interior volume at the same phase, and as the distance from the center to the periphery increases, they add up with the minimal difference in phase. In other words, here interference manifests itself not in mutual suppression of acoustic waves generated by individual cavities but rather in their mutual amplification. Thus, at any given time the modulus of the total instantaneous value of pressure in the reactor center will be at its maximum. Hence, potential energy density, which is proportional to the square of pressure, will also be at its maximum. For this, there will be no need to increase the wave emission area, static pressure in liquid and, accordingly, emitter power. And in this case liquid in the reactor will be exposed to the most intense effect of cavitation.

Using the known pattern of distribution of potential energy of multi-bubble cavitation relative to the harmonic wave that generates it, one can compare the above example of specific implementation of this invention to the prototype that has the same reactor design and dimensions but does not have a shift of resonator oscillation phases. According to this pattern, average density of potential energy of cavitation over the entire reactor internal volume in the claimed reactor is 3.2 times higher than in the prototype.

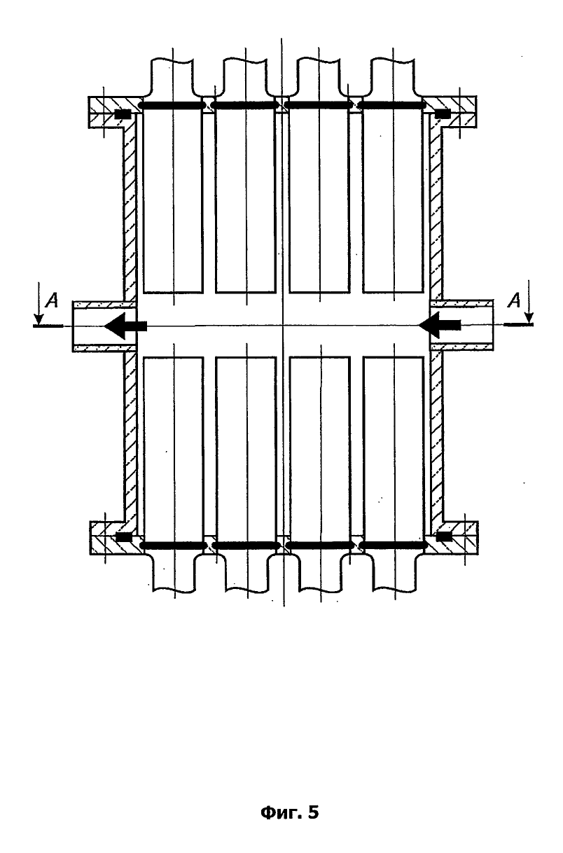

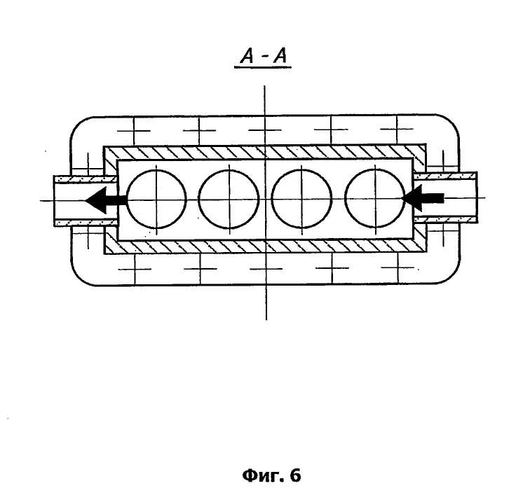

The reactor can have any number and a random placement of resonators. As an example, FIGS. 5 and 6 show a rectangular in a plan view reactor, the housing design and the number of resonators 1-1′, 2-2′, 3-3′ and 4-4′. The transducers are attached to waveguide transformers they activate, which in turn are attached to the housing at natural oscillation units. This makes it possible to set the wave phase in each resonator randomly without risking destruction of the reactor structure.

To corroborate the feasibility of actual reduction of this invention, to practice and achievement of the technical result by using it, a full-scale experiment was used. Emitters of the type “SI-RINKS” SITB.443146.002 TU apparatus for cavitation disintegration of liquid food media with electroacoustic magnetostriction transducers with 22 kHz frequency were used as resonator emitters. The experiment was set up using the methodology for studying the effect of cavitation intensity on the degree of dissociation of electrolytes with ionic-type bond. The methodology is described in D. T. N. [Doctor of Technical Sciences] Rogov and D. T. N. Shestakov work “The Epithermal Change of Thermodynamic Equilibrium of Water and Water Solutions” published in RASKhN [the Russian Academy of Agricultural Sciences] magazine “Khranenie i pererabotka selkhozsyrya” MlO, 2004. Three half-way resonators including 38 mm diameter solid-state waveguides of laboratory apparatus “SIRINKS” and elastic reflectors made of vacuum rubber were placed in a straight line, with the 74 mm distance between the waveguide axes, in an open cylindrical vessel or reactor filled with 1400 ml of liquid flowing through it. The phase shift of magnetostriction transducers of peripheral resonators with respect to the central resonator was achieved by using a delay circuit including controlled univibrator circuits. The advance phase shift between resonator oscillations was 43 μs, while when reproducing operation of the prototype it was 0 μs. Electric power supplied to apparatus “SIRINKS” power sources during the experiment remained stable. Static pressure in the reactor was not changed either and was equal to atmospheric pressure because the reactor formed an open vessel. The ambient temperature was +20° C. and had been maintained accurate to ±1° C. A centinormal potassium chloride solution was fed through the reactor at the speed of 500±10 ml/min in the direction perpendicular to the axis along which the resonators were installed; a laboratory pump and adjustable orifice were used. A conductivity transducer of device “Anion 7051” (INFRASPAK, Novosibirsk) was installed in the direction of electrolyte flow behind the resonator located in the reactor center. In a steady-state operation mode of the experimental installation, the following average instrument readings were obtained in each phase shift version while the experiment was repeated five times.

| | PAREMETER MEASURED, | |
|---|---|---|
| | PHASE SHIFT OFF | PHASE SHIFT ON |
| Unit of measurement | (PROTOTYPE) | (INVENTION) |
| Conductivity, mS/m | 1.26 ± 0.04 | 1.35 ± 0.03 |

As shown in the table, in the second case the degree of sodium chloride dissociation into ions, which determines the solution conductivity, is higher. This indicates a more intense effect of cavitation on solution, which results in practically one hundred percent dissociation of NaCl.

1. A cavitation reactor for processing liquid media that contains a source of harmonic oscillations in a form of resonators with a same frequency which form elastic stationary waves in liquid, wherein the source of harmonic oscillations is made with a capability to shift phases forward as a distance from a reactor center increases.

2. A cavitation reactor according to claim 1, wherein an amount of phase shift of each resonator is equal to a ratio of a distance between a resonator oscillation node and a reactor to a wavelength in liquid.
